(19) United States
(12) Patent Application Publication
(10) Pub. No.: US 2013/0308241 A1
(43) Pub. Date: Nov. 21, 2013

(54) SURGE SUPPRESSION CIRCUIT

(71) Applicant: HON HAI PRECISION INDUSTRY CO., LTD., New Taipei (TW)

(72) Inventors: CHUN-AN LAI, New Taipei (TW); WEI-LUNG HUANG, New Taipei (TW); CHI-KUNG SU, New Taipei (TW); WEI-CHIH KUO, New Taipei (TW)

(73) Assignee: HON HAI PRECISION INDUSTRY CO., LTD., New Taipei (TW)

(21) Appl. No.: 13/875,324

(22) Filed: May 2, 2013

(30) Foreign Application Priority Data
May 18, 2012 (TW) 101117707

(51) Int. Cl. H02H 9/08

(52) U.S. Cl. CPC H02H 9/08
USPC 361/118

(57) ABSTRACT

A surge suppression circuit includes a metal oxide semiconductor field effect transistor (MOSFET), a first resistor, a first capacitor, and a passive component. The MOSFET, the first resistor, and the first capacitor are integrated to form an integrated circuit. The first capacitor and the first resistor are connected in series between a drain and a source of the MOSFET; the passive component is disposed outside of a package of the integrated circuit, the passive component is electronically connected between the first resistor and the first capacitor, or is electronically connected in parallel with one of the first resistor and the first capacitor.

### BACKGROUND

1. Technical Field

The exemplary disclosure generally relates to surge suppression circuits, and particularly to a surge suppression circuit for a metal oxide semiconductor field effect transistor (MOSFET).

2. Description of Related Art

A metal oxide semiconductor field effect transistor (MOSFET) used in power supply circuits usually serves as a switch. In use, the MOSFET is easily damaged by transient voltage spikes generated by the power supply circuit. FIG. 5 shows a typical surge suppression circuit 100 including a MOSFET 11, a resistor 12, and a capacitor 13. The MOSFET 11, the resistor 12, and the capacitor 13 are integrated into a single chip. The resistor 12 and the capacitor 13 are electronically connected in series between a drain D and a source S of the MOSFET 11. The resistor 12 and the capacitor 13 are used to block the transient voltage spikes output to the gate G of the MOSFET.

However, since the resistor 12 and the capacitor 13 are integrated into the single chip, once the single chip is manufactured, the resistance of the resistor 12 and the capacitance of the capacitor 13 cannot be regulated. Therefore, the aforementioned surge suppression circuit 100 can only be used to estimate the transient voltage spikes at a certain frequency.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

FIG. 1 shows a circuit diagram of a first embodiment of a surge suppression circuit.

FIG. 2 shows a circuit diagram of a second embodiment of a surge suppression circuit.

FIG. 3 shows a circuit diagram of a third embodiment of a surge suppression circuit.

FIG. 4 shows a circuit diagram of a fourth embodiment of a surge suppression circuit.

FIG. 5 shows a circuit diagram of a known surge suppression circuit.

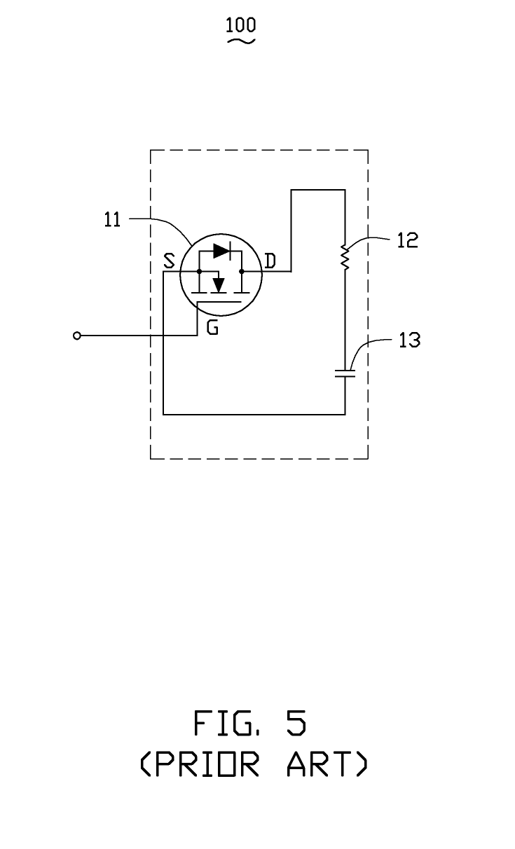

### DETAILED DESCRIPTION

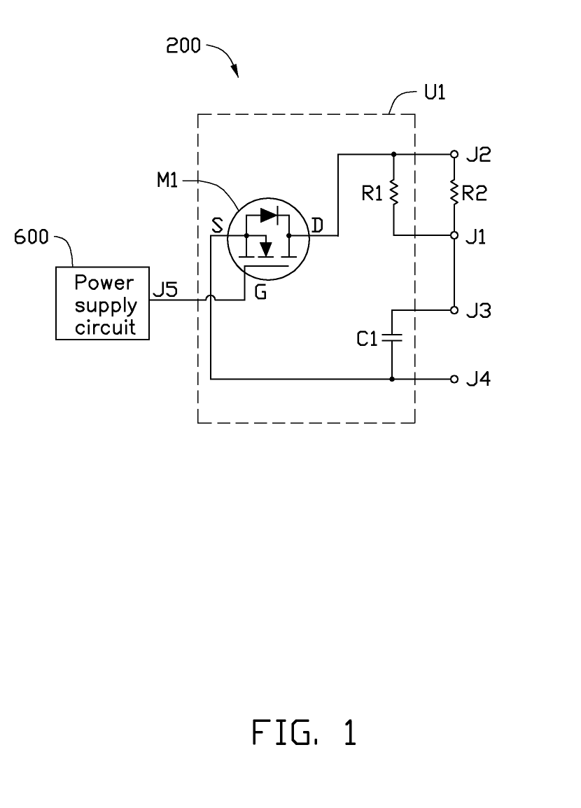

FIG. 1 shows a circuit diagram of a first embodiment of a surge suppression circuit 200. The surge suppression circuit 200 can be used for a power supply circuit 600, to estimate transient voltage spikes generated by the power supply circuit 600. The surge suppression circuit 200 includes a metal oxide semiconductor field effect transistor (MOSFET) M1, a first resistor R1, a first capacitor C1, and a passive component. The MOSFET M1, the first resistor R1 and the first capacitor C1 are packaged and integrated into an integrated circuit (IC), that is, a chip U1 shown in FIG. 1. The chip U1 further includes five terminals J1-J5. The first resistor R1 is electronically connected between the terminal J1 and a drain D of the MOSFET M1. A node between the first resistor R1 and the drain D of the MOSFET M1 is the terminal J2. The first capacitor C1 is electronically connected between the terminal J3 and a source S of the MOSFET M1. A node between the first capacitor C1 and the MOSFET M1 is the terminal J4. A gate G of the MOSFET M1 is electronically connected to the power supply circuit 600 via the terminal J5.

In the first embodiment, the passive component is a second resistor R2. The second resistor R2 is disposed outside of the package of the chip U1, and is electronically connected between the terminals J1 and J2. The terminal J1 is electronically connected to the terminal J3, such that the first resistor R1 and the first capacitor C1 is electronically connected in series between the source S and the drain D of the MOSFET M1, and the second resistor R2 is electronically connected to the first resistor R1 in parallel. The first and second resistors R1, R2 and the first capacitor C1 cooperate to block transient voltage spikes that are generated by the power supply circuit 600. Since the first resistor R1 and the first capacitor C1 are integrated with the MOSFET M1, a transmission length of the transient voltage spikes is short relative to a transmission length in a situation disposing the capacitor C1 and the first resistor R1 outside of the package of the chip U1. The first and second resistors R1 and R2 are all disposed outside of the package of the chip U1, which can achieve a preferable effect of surge suppression. Furthermore, since the second resistor R2 is disposed outside of the package of the chip U1, the resistance of the second resistor R2 can be selected to satisfy different requirements, such that the surge suppression circuit 200 can estimate transient voltage spikes with various frequencies by changing the resistance of the second resistor R2.

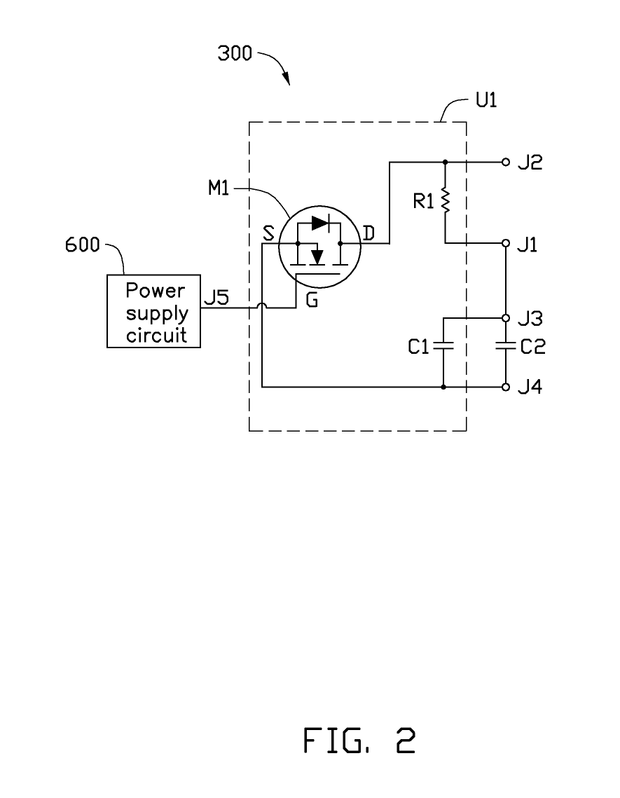

FIG. 2 shows a circuit diagram of a second embodiment of a surge suppression circuit 300. The surge suppression circuit 300 has substantially the same components and electronic connections relationship as the components and electronic connections of the surge suppression circuit 200, and differs from the surge suppression circuit 200 only in that the passive component of the surge suppression circuit 300 is a second capacitor C2. The second capacitor C2 is disposed outside of the package of the chip U1, and is electronically connected between the terminal J3 and the terminal J4. The terminal J1 is electronically connected to the terminal J3, such that the first resistor R1 and the first capacitor C1 is electronically connected in series between the source S and the drain D of the MOSFET M1, and the second capacitor C2 is electronically connected to the first capacitor C1 in parallel. The first and second capacitors C1, C2 and the first resistor R1 cooperate to block transient voltage spikes that are generated by the power supply circuit 600 and are output to the gate G of the MOSFET M1. Since the second capacitor C2 is disposed outside of the package of the chip U1, the capacitance of the second capacitor C2 can be selected to satisfy different requirements, such that the surge suppression circuit 300 can estimate various frequency transient voltage spikes by selecting the capacitance of the second capacitor C2.

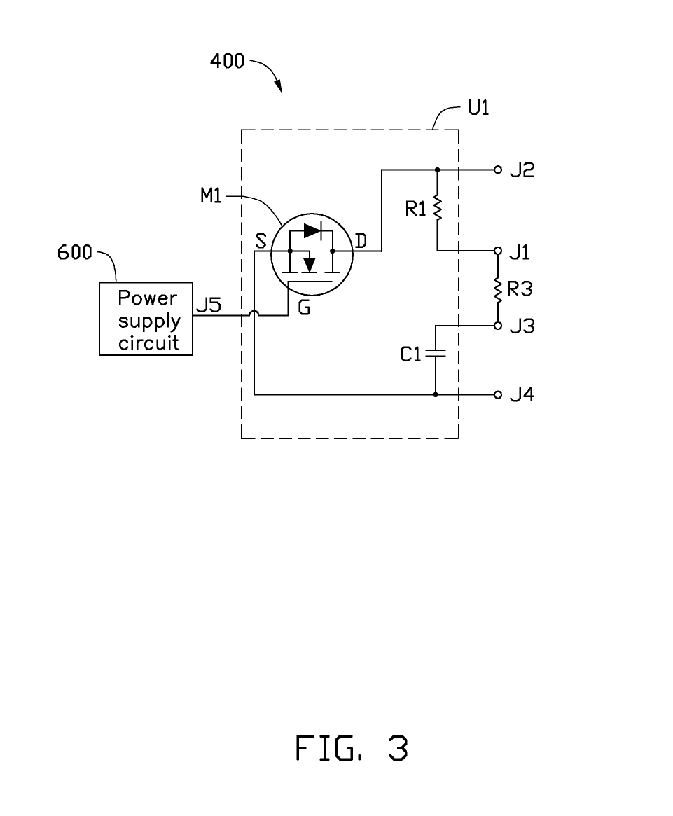

FIG. 3 shows a circuit diagram of a third embodiment of a surge suppression circuit 400. The surge suppression circuit 400 has substantially the same components and electronic connections relationship as the components and electronic connections of the surge suppression circuit 200, and differs from the surge suppression circuit 200 only in that the passive component of the surge suppression circuit 400 is a third resistor R3. The third resistor R3 is disposed outside of the package of the chip U1, and is electronically connected between the terminals J1 and J3, such that the first resistor R1, the third resistor R3 and the first capacitor C1 are electronically connected in series between the source S and the drain D of the MOSFET M1. The first and third resistors R1, R3 and the first capacitor C1 cooperate to block transient voltage spikes that are generated by the power supply circuit 600 and are output to the gate G of the MOSFET M1. Since the third resistor R3 is disposed outside of the package of the chip U1, the resistance of the third resistor R3 can be selected to satisfy different requirements, such that the surge suppression circuit 400 can estimate various frequency transient voltage spikes by selecting the resistance of the third resistor R3.

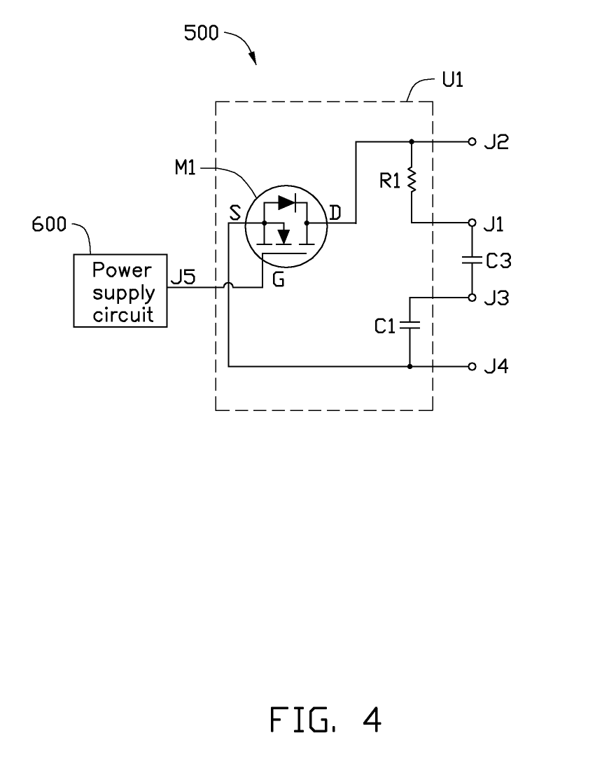

FIG. 4 shows a circuit diagram of a fourth embodiment of a surge suppression circuit 500. The surge suppression circuit 500 has substantially the same components and electronic connections relationship as the components and electronic connections of the surge suppression circuit 200, and differs from the surge suppression circuit 200 only in that the passive component of the surge suppression circuit 500 is a third capacitor C3. The third capacitor C3 is disposed outside of the package of the chip U1, and is electronically connected between the terminal J1 and the terminal J3 such that the first resistor R1, the third capacitor C3, and the first capacitor C1 is electronically connected in series between the source S and the drain D of the MOSFET M1. The first and third capacitors C1, C3 and the first resistor R1 cooperate to block transient voltage spikes that are generated by the power supply circuit 600 and are output to the gate G of the MOSFET M1. Since the third capacitor C3 is disposed outside of the package of the chip U1, the capacitance of the third capacitor C3 can be selected to satisfy different requirement, such that the surge suppression circuit 500 can estimate various frequency transient voltage spikes by selecting the capacitance of the third capacitor C3.

In other embodiment, a surge suppression circuit includes at least two passive components. For example, in one embodiment, a surge suppression circuit can includes both the second resistor R2 connected to the first resistor R1 in parallel, and the second capacitor C2 connected to the first capacitor C1 in parallel.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A surge suppression circuit, comprising:
a metal oxide semiconductor field effect transistor (MOSFET);
a first resistor;
a first capacitor; and
a passive component;
wherein the MOSFET, the first resistor, and the first capacitor are integrated to form an integrated circuit, the first capacitor and the first resistor are connected in series between a drain and a source of the MOSFET; the passive component is disposed outside of a package of the integrated circuit, the passive component is electronically connected between the first resistor and the first capacitor, or is electronically connected in parallel with one of the first resistor and the first capacitor.

2. The surge suppression circuit of claim 1, wherein the integrated circuit comprises a first terminal, a second terminal, and a third terminal electronically connected to the first terminal; the first resistor is electronically connected between the first terminal and the drain of the MOSFET; a node between the first resistor and the drain of the MOSFET is electronically connected to the second terminal; the first capacitor is electronically connected between the source of the MOSFET and the third terminal; the passive component is a resistor electronically connected between the first and second terminals.

3. The surge suppression circuit of claim 1, wherein the integrated circuit comprises a first terminal, a second terminal, and a third terminal electronically connected to the first terminal; the first capacitor is electronically connected between the first terminal and the source of the MOSFET; a node between the first capacitor and the source of the MOSFET is electronically connected to the second terminal; the first resistor is electronically connected between the drain of the MOSFET and the third terminal; the passive component is a capacitor electronically connected between the first and second terminals.

4. The surge suppression circuit of claim 1, wherein the integrated circuit comprises a first terminal and a second terminal; the first resistor is electronically connected between the first terminal and the drain of the MOSFET; the first capacitor is electronically connected between the second terminal and the source of the MOSFET; the passive component is a resistor electronically connected between the first and second terminals.

5. The surge suppression circuit of claim 1, wherein the integrated circuit comprises a first terminal and a second terminal; the first resistor is electronically connected between the first terminal and the drain of the MOSFET; the first capacitor is electronically connected between the second terminal and the source of the MOSFET; the passive component is a capacitor electronically connected between the first and second terminals.

6. The surge suppression circuit of claim 1, wherein the gate of the MOSFET is electronically connected to a power supply circuit.
